(19) United States
(12) Patent Application Publication
(10) Pub. No.: US 2026/0290806 A1
(43) Pub. Date: Sep. 24, 2026

(54) CATHODE ACTIVE MATERIAL AND LITHIUM-ION BATTERY

(71) Applicant: TOYOTA JIDOSHA KABUSHIKI KAISHA, Toyota-shi (JP)

(72) Inventors: Momoko PROCTER, Seto-shi (JP); Yuji Mahara, Seto-shi (JP)

(73) Assignee: TOYOTA JIDOSHA KABUSHIKI KAISHA, Toyota-shi (JP)

(21) Appl. No.: 19/443,441

(22) Filed: Jan. 8, 2026

(30) Foreign Application Priority Data
Mar. 21, 2025 (JP) 2025-046935

(51) Int. Cl. H01M 4/525; H01M 4/02; H01M 4/505; H01M 10/0525

(52) U.S. Cl. CPC H01M 4/525; H01M 4/505; H01M 10/0525; H01M 2004/021; H01M 2004/028

(57) ABSTRACT

A cathode active material is a single-crystal active material composed of crystalline primary particles having a composition represented by LiₓNiₐCo_{b}MncO_{y} (where 0.1≤x≤1.5, 0.5≤a≤1.0, 0≤b≤0.3, 0≤c≤0.3, a+b+c=1.0, and 1.5≤y≤2.1), and having, as a main phase, a crystal structure belonging to space group R-3m. An asymmetry degree calculated from (dₚₑₐₖ−d_{high})/(d_{low}−dₚₑₐₖ) is 1.14 or more, where dₚₑₐₖ represents a plane spacing calculated from 2θ of a peak derived from reflection at a (003) plane and obtained by X-ray diffraction, d_{low} represents a plane spacing calculated from 2θ on a low-angle side corresponding to 5% of a peak intensity of the peak, and d_{high} represents a plane spacing calculated from 2θ on a high-angle side corresponding to 5% of the peak intensity.

### CROSS-REFERENCE TO RELATED APPLICATION

This application claims priority to Japanese Patent Application No. 2025-046935 filed on Mar. 21, 2025. The disclosure of the above-identified application, including the specification, drawings, and claims, is incorporated by reference herein in its entirety.

### BACKGROUND

### 1. Technical Field

The present disclosure relates to cathode active materials and lithium-ion batteries.

### 2. Description of Related Art

Battery development has been active in recent years. For example, in the automotive industry, lithium-ion batteries for use in battery electric vehicles (BEVs), plug-in hybrid electric vehicles (PHEVs), and hybrid electric vehicles (HEVs) have been actively developed. Further, various studies have been conducted on cathode active materials for lithium-ion batteries.

For example, Japanese Unexamined Patent Application Publication No. 2023-516229 (JP 2023-516229 A) discloses a lithium-nickel-cobalt-manganese composite oxide as a cathode active material. Japanese Unexamined Patent Application Publication No. 2012-204311 (JP 2012-204311 A) discloses a cathode active material containing a lithium-rich ternary compound represented by a general formula of Li_{1+X}MnⱼCoₖNi_{L}O₂ (where 0.4≤x≤1.0; 0<j<1; 0<k<1; and 0<L<1). Japanese Unexamined Patent Application Publication No. 2013-137962 (JP 2013-137962 A) discloses a cathode active material represented by a compositional formula of Li₂₋ₓMn₁₋ₓCoₓNiₓO₃ (0.3≤x≤0.5).

### SUMMARY

From the viewpoint of improving battery performance, it is desirable for a battery to exhibit good capacity retention even after repeated charge and discharge cycles. The present disclosure has been made in view of such circumstances, and a primary object thereof is to provide a cathode active material that can improve the capacity retention of a lithium-ion battery.
(1) A cathode active material for use in a lithium-ion battery, in which:
the cathode active material is a single-crystal active material composed of crystalline primary particles;
the primary particles have a composition represented by LiₓNiₐCo_{b}MncO_{y} (where 0.1≤x≤1.5, 0.5≤a≤1.0, 0≤b≤0.3, 0≤c≤0.3, a+b+c=1.0, and 1.5≤y≤2.1);
the primary particles have, as a main phase, a crystal structure belonging to space group R-3m; and
an asymmetry degree calculated from (dₚₑₐₖ−d_{high})/(d_{low}−dₚₑₐₖ) is 1.14 or more, where dₚₑₐₖ represents a plane spacing calculated from 2θ of a peak derived from reflection at a (003) plane and obtained by X-ray diffraction, d_{low} represents a plane spacing calculated from 2θ on a low-angle side corresponding to 5% of a peak intensity of the peak, and d_{high} represents a plane spacing calculated from 2θ on a high-angle side corresponding to 5% of the peak intensity of the peak.
(2) The cathode active material according to (1), in which the asymmetry degree is 1.20 or less.
(3) The cathode active material according to (1) or (2), in which the b is 0, and the c is more than 0.
(4) The cathode active material according to any one of (1) to (3), in which a particle size of the primary particles is 0.5 m or more.
(5) A lithium-ion battery including: a cathode active material layer; an anode active material layer; and an electrolyte layer disposed between the cathode active material layer and the anode active material layer, in which
the cathode active material layer contains the cathode active material according to any one of (1) to (4).

The present disclosure can provide a cathode active material that can improve the capacity retention of a lithium-ion battery.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an asymmetry degree in the present disclosure;

FIG. 2 is a schematic sectional view illustrating a lithium-ion battery according to the present disclosure;

FIG. 3A shows an X-ray diffraction (XRD) pattern of a cathode active material produced in Example 1; and

FIG. 3B shows the XRD pattern of the cathode active material produced in Example 1.

### DETAILED DESCRIPTION OF EMBODIMENTS

The cathode active material and the lithium-ion battery according to the present disclosure will now be described in detail. The drawings referenced below are provided for illustration purposes, and the sizes and shapes of the components may be exaggerated in some cases for better understanding. In the present disclosure, the lithium-ion battery may be referred to simply as “battery.”

### A. Cathode Active Material

The cathode active material of the present disclosure is a cathode active material for use in a lithium-ion battery. The cathode active material is a single-crystal active material composed of crystalline primary particles. The primary particles have a composition represented by LiₓNiₐCo_{b}Mn_{c}O_{y} (where 0.1≤x≤1.5, 0.5≤a≤1.0, 0≤b≤0.3, 0≤c≤0.3, a+b+c=1.0, and 1.5≤y≤2.1), and have, as a main phase, a crystal structure belonging to space group R-3m. An asymmetry degree calculated from (dₚₑₐₖ−d_{high})/(d_{low}−dₚₑₐₖ) is 1.14 or more, where dₚₑₐₖ represents a plane spacing calculated from 2θ of a peak derived from reflection at a (003) plane and obtained by X-ray diffraction, d_{low} represents a plane spacing calculated from 2θ on a low-angle side corresponding to 5% of a peak intensity of the peak, and d_{high} represents a plane spacing calculated from 2θ on a high-angle side corresponding to 5% of the peak intensity of the peak.

According to the present disclosure, the crystalline primary particles having the predetermined composition have the asymmetry degree of 1.14 or more. Therefore, the cathode active material can improve the capacity retention of a lithium-ion battery.

As disclosed in JP 2023-516229 A, JP 2012-204311 A, and JP 2013-137962 A, studies have been conducted, for example, on the use of a lithium metal composite oxide such as an NCM-based active material as a cathode active material. It is expected that a high-capacity cathode active material can be obtained from the lithium metal composite oxide by increasing the proportion of Ni. When charge and discharge are performed particularly in a high-potential region, irreversible contraction in the c-axis direction may occur due to desorption of lithium ions. When such contraction occurs, Ni may migrate to the Li phase and an inactive nickel oxide (NiO) phase may be generated, which may result in a decrease in capacity retention of the battery.

The present inventors have found that the crystal structure can be stabilized particularly in the high-potential region by intentionally introducing compressive strain into the crystal structure. The present disclosure has been completed by determining the compressive strain based on the peak derived from the (003) plane.

### 1. Primary Particles

In the present disclosure, the cathode active material is composed of crystalline primary particles. The primary particles have a predetermined composition. The composition will be described later.

The primary particles have, as a main phase, a crystal structure belonging to the space group R-3m. The term “main phase” refers to the crystal phase that gives the highest-intensity peak in X-ray diffraction (XRD) measurement. An example of crystal structures belonging to the space group R-3m is a layered rock-salt crystal structure.

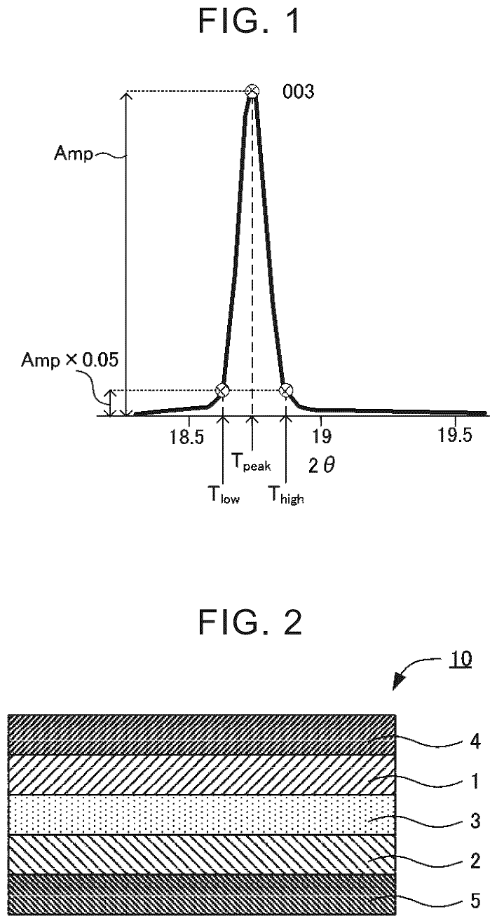

In particular, in the primary particles of the present disclosure, the asymmetry degree calculated from the predetermined plane spacings (dₚₑₐₖ, d_{low}, and d_{high}) is 1.14 or more. Hereinafter, methods for determining the plane spacings and the asymmetry degree will be described with reference to FIG. 1. FIG. 1 is a graph schematically showing a peak derived from reflection at the (003) plane and obtained by X-ray diffraction. In X-ray diffraction using synchrotron X-rays (17 keV, monochromatic), as shown in FIG. 1, the peak derived from reflection at the (003) plane is typically obtained at 2θ=18.0° to 19.0°. First, the obtained peak is fitted with a Gaussian function, and the angle (2θ) of the peak top is defined as Tₚₑₐₖ. Next, the intensity of the peak at Tₚₑₐₖ is defined as Amp. In the determination of the peak intensity, the background may be removed using a line connecting the positions of 2θ=18.5° and 19.0° in the above peak. For angles showing intensities that are 5% (Amp×0.05) of the intensity of the peak at Tₚₑₐₖ, the larger angle is defined as T_{high} and the smaller angle is defined as T_{low}. Next, Tₚₑₐₖ, T_{high}, and T_{low} determined above are converted into plane spacings (dₚₑₐₖ, d_{high}, and d_{low}) using the Bragg's law. Then, the asymmetry degree is calculated from the expression: (dₚₑₐₖ−d_{high})/(d_{low}−dₚₑₐₖ).

When the asymmetry degree calculated from the above expression is more than 1.0, that is, when tailing is observed on the high-angle side of the peak, it can be determined that crystallites having compressive strain are present. When the asymmetry degree calculated from the above expression is 1, it can be determined that the peak is symmetrical and no compressive strain is introduced.

In the present disclosure, the asymmetry degree is 1.14 or more. The asymmetry degree may be 1.15 or more, 1.16 or more, 1.17 or more, or 1.18 or more. The asymmetry degree is, for example, 1.20 or less, and may be 1.19 or less.

The primary particles according to the present disclosure have the composition represented by LiₓNiₐCo_{b}Mn_{c}O_{y} (where 0.1≤x≤1.5, 0.5≤a≤1.0, 0≤b≤0.3, 0≤c≤0.3, a+b+c=1.0, and 1.5≤y≤2.1).

The value x may be 0.4 or more, 0.6 or more, 0.8 or more, or 1.0 or more. The value x may be 1.4 or less, or 1.2 or less.

The value y may be 1.6 or more, 1.7 or more, 1.8 or more, or 1.9 or more. The value y may be 2.0 or less.

The value a may be 0.6 or more, 0.7 or more, 0.8 or more, or 0.85 or more. The value a may be 0.9 or less.

The value b may be 0 or more than 0. That is, the primary particles may or may not contain Co, but the former is preferred. This is from the perspective of avoiding resource risks. The value b may be 0.01 or more, 0.03 or more, 0.05 or more, or 0.07 or more. The value b may be 0.25 or less, 0.20 or less, 0.15 or less, or 0.10 or less.

The value c may be 0 or more than 0. That is, the primary particles may or may not contain Mn, but the latter is preferred. The value c may be 0.01 or more, 0.03 or more, 0.05 or more, or 0.07 or more. The value c may be 0.25 or less, 0.20 or less, 0.15 or less, or 0.10 or less.

An example of the composition of the primary particles is LiNi_{0.89-0.97}Co_{0-0.05}Mn_{0.03-0.06}O₂. This corresponds to x=1, y=2, 0.89≤a≤0.97, 0≤b≤0.05, and 0.03≤c≤0.06 in the above compositional formula.

Specific examples of the composition of the primary particles include LiNi_{0.95}Mn_{0.05}O₂, LiNi_{0.90}Mn_{0.10}O₂, LiNi_{0.5}Co_{0.2}Mn_{0.3}O₂, LiNi_{0.5}Co_{0.3}Mn_{0.2}O₂, LiNi_{0.5}Co_{0.4}Mn_{0.1}O₂, LiNi_{0.5}Co_{0.1}Mn_{0.4}O₂, LiNi_{0.6}Co_{0.2}Mn_{0.2}O₂, LiNi_{0.6}Co_{0.3}Mn_{0.1}O₂, LiNi_{0.6}Co_{0.1}iMn_{0.3}O₂, LiNi_{0.7}Co_{0.1}Mn_{0.2}O₂, LiNi_{0.7}Co_{0.2}Mn_{0.1}O₂, LiNi_{0.8}Co_{0.1}Mn_{0.1}O₂, LiNi_{0.9}Co_{0.05}Mn_{0.05}O₂, and LiNi_{0.92}Co_{0.04}Mn_{0.04}O₂.

The composition of the primary particles can be determined by, for example, dissolving the cathode active material in an acid and measuring the resulting solution using inductively coupled plasma optical emission spectroscopy (ICP-OES).

The particle size of the primary particles is, for example, 0.5 μm or more, and may be 0.6 μm or more, 0.8 μm or more, 1 μm or more, 2 μm or more, or 5 μm or more. The particle size of the primary particles is, for example, 20 μm or less, and may be 15 μm or less, or 10 μm or less. The particle size of each primary particle can be obtained as, for example, the maximum diameter observed using a scanning electron microscope (SEM). For example, in the state of the battery described later, the particle size (maximum diameter) of each primary particle may be determined from a cross-sectional image of the cathode active material layer.

### 2. Cathode Active Material

The cathode active material of the present disclosure is typically a single-crystal active material composed of the primary particles described above. The term “single-crystal active material” refers to an active material that is not a polycrystalline active material (an active material that is a dense aggregate of numerous primary particles). A single-crystal active material is typically not aggregated and exists as independent particles. It is preferable that no grain boundaries be observed in a single-crystal active material in scanning electron microscope (SEM) observation (at a magnification of about 10,000× to about 30,000×). A single-crystal active material exhibits less degradation over time than a polycrystalline active material.

The average particle size of the cathode active material is, for example, more than 0.5 μm and 30 μm or less, and may be 0.8 μm or more and 25 μm or less, 1 μm or more and 20 μm or less, or 2 μm or more and 15 μm or less. The cathode active material is, for example, in the form of particles.

The method for producing the cathode active material of the present disclosure is not particularly limited, and may be, for example, the method described in the Example below. The cathode active material of the present disclosure is used in a lithium-ion battery. A lithium-ion battery will be described below.

### B. Lithium-Ion Battery

FIG. 2 is a schematic sectional view illustrating the lithium-ion battery according to the present disclosure. A lithium-ion battery 10 shown in FIG. 2 includes a cathode active material layer 1, an anode active material layer 2, an electrolyte layer 3 disposed between the cathode active material layer 1 and the anode active material layer 2, a cathode current collector 4 that collects electrons from the cathode active material layer 1, and an anode current collector 5 that collects electrons from the anode active material layer 2. The cathode active material layer 1 of the lithium-ion battery 10 contains the cathode active material of the present disclosure described above.

In the present disclosure, since the cathode active material described above is used, the lithium-ion battery exhibits good capacity retention.

### 1. Cathode Active Material Layer

The cathode active material layer contains the cathode active material described above. Since the details of the cathode active material are the same as those given in section “A. Cathode Active Material,” description thereof will be omitted.

The proportion of the cathode active material in the cathode active material layer is, for example, 20 mass % or more, and may be 30 mass % or more, or 40 mass % or more. If the proportion of the cathode active material is too low, sufficient energy density may not be obtained. The proportion of the cathode active material in the cathode active material layer is, for example, 95 mass % or less, and may be 70 mass % or less, or 60 mass % or less. If the proportion of the cathode active material is too high, the ionic conductive properties and electronic conductive properties of the cathode active material layer may relatively decrease.

The cathode active material layer may contain an electrically conductive material. The addition of an electrically conductive material improves the electronic conductive properties. Examples of electrically conductive materials include carbon-based electrically conductive materials, metal particles, and electrically conductive polymers. Examples of carbon-based electrically conductive materials include particulate materials such as acetylene black (AB) and Ketjenblack (KB), and fibrous materials such as vapor-grown carbon fibers (VGCFs), carbon nanotubes (CNTs), and carbon nanofibers (CNFs). The proportion of the electrically conductive material in the cathode active material layer is, for example, 0.1 mass % or more and 5 mass % or less. If the proportion of the electrically conductive material is too low, there may not be sufficient electron conduction paths. If the proportion of the electrically conductive material is too high, the proportion of the cathode active material relatively decreases, which may lower the energy density.

The cathode active material layer may contain a binder. Examples of binders include rubber-based binders such as styrene-butadiene rubber (SBR) and butadiene rubber (BR), polycarboxylic-acid-based binders such as carboxymethyl cellulose, and fluoride-based binders such as polyvinylidene fluoride (PVdF). The proportion of the binder in the cathode active material layer is, for example, 0.5 mass % or more and 15 mass % or less.

The cathode active material layer may contain an electrolyte. The electrolyte is described in section “3. Electrolyte Layer” below. The thickness of the cathode active material layer is, for example, 30 μm or more and 1000 μm or less.

### 2. Anode Active Material Layer

The anode active material layer contains at least an anode active material. Examples of anode active materials include carbon-based active materials, Li-based active materials, Si-based active materials, and oxide-based active materials.

Examples of carbon-based active materials include graphite, soft carbon, and hard carbon. The graphite may be either natural graphite or artificial graphite. Examples of Li-based active materials include Li and Li alloys. Examples of Li alloys include Li—Si alloys. Examples of Si-based active materials include Si, SiC composite active materials, Si alloys, and silicon oxides. Examples of SiC composite active materials include active materials in which Si or an Si alloy is supported on a carbon support. Examples of oxide-based active materials include lithium titanate such as Li₄Ti₅O₁₂.

The proportion of the anode active material in the anode active material layer is, for example, 20 mass % or more, and may be 30 mass % or more, or 40 mass % or more. If the proportion of the anode active material is too low, sufficient energy density may not be obtained. The proportion of the anode active material in the anode active material layer is, for example, 95 mass % or less, and may be 70 mass % or less, or 60 mass % or less. If the proportion of the anode active material is too high, the ionic conductive properties and electronic conductive properties of the anode active material layer may relatively decrease.

The anode active material layer may contain at least one selected from an electrically conductive material, a binder, and an electrolyte. The details of the electrically conductive material, binder, and electrolyte are the same as those described in section “1. Cathode Active Material Layer.” The thickness of the anode active material layer is, for example, 30 μm or more and 1000 μm or less.

### 3. Electrolyte Layer

The electrolyte layer is a layer disposed between the cathode active material layer and the anode active material layer, and contains at least an electrolyte. The electrolyte is, for example, a liquid electrolyte (electrolyte solution).

An example of the electrolyte solution is a non-aqueous electrolyte solution. A non-aqueous electrolyte solution contains, for example, a lithium salt and a non-aqueous solvent. Examples of lithium salts include inorganic lithium salts such as LiPF₆, LiBF₄, LiClO₄, and LiAsF₆, and organic lithium salts such as LiCF₃SO₃, LiN(SO₂CF₃)₂, LiN(SO₂C₂F₅)₂, and LiC(SO₂CF₃)₃.

Examples of non-aqueous solvents include carbonate-based solvents such as ethylene carbonate (EC), propylene carbonate (PC), butylene carbonate (BC), dimethyl carbonate (DMC), diethyl carbonate (DEC), and ethyl methyl carbonate (EMC). The non-aqueous solvent may be a mixture of a cyclic carbonate having a high dielectric constant and high viscosity, such as EC or PC, and a chain carbonate having a low dielectric constant and low viscosity, such as DMC, DEC, or EMC. The concentration of the lithium salt in the non-aqueous electrolyte solution is, for example, 0.3 M or more and 5 M or less. The non-aqueous electrolyte solution may contain an ionic liquid. Examples of ionic liquids include sulfonium salts, ammonium salts, pyridinium salts, piperidinium salts, pyrrolidinium salts, morpholinium salts, phosphonium salts, and imidazolium salts.

Another example of the electrolyte solution is an aqueous electrolyte solution. An aqueous electrolyte solution is an electrolyte solution containing water as a main component of the solvent. The proportion of water relative to the total solvent is, for example, 50 mass % or more, and may be 70 mass % or more. Examples of lithium salts used in the aqueous electrolyte solution include imide-based electrolytes such as lithium bis(fluorosulfonyl)imide and lithium bis(trifluoromethanesulfonyl)imide. The concentration of the lithium salt in the aqueous electrolyte solution is, for example, 1 M or more and 25 M or less.

The electrolyte layer may include a separator impregnated with the electrolyte solution described above. The separator material may be a conventionally known material. The electrolyte layer may contain a solid electrolyte. Examples of solid electrolytes include organic solid electrolytes such as polymer electrolytes and gel electrolytes, and inorganic solid electrolytes such as sulfide solid electrolytes, oxide solid electrolytes, and halide solid electrolytes.

### 4. Lithium-Ion Battery

The lithium-ion battery of the present disclosure preferably includes a cathode current collector that collects current from the cathode active material layer, and an anode current collector that collects current from the anode active material layer. Examples of materials for the cathode current collector include stainless steel (steel use stainless (SUS)), aluminum, nickel, iron, titanium, and carbon. Examples of materials for the anode current collector include SUS, copper, nickel, and carbon. The battery of the present disclosure may include an outer casing that houses a power-generating element (the cathode active material layer, the electrolyte layer, and the anode active material layer). Examples of outer casings include case-type casings and laminate-type casings.

The lithium-ion battery of the present disclosure may be either a primary battery or a secondary battery, but is preferably a secondary battery. This is because a secondary battery can be repeatedly charged and discharged and is therefore useful as, for example, an in-vehicle battery. Examples of applications of lithium-ion batteries include power sources for vehicles such as hybrid electric vehicles (HEVs), plug-in hybrid electric vehicles (PHEVs), battery electric vehicles (BEVs), gasoline vehicles, and diesel vehicles. In particular, lithium-ion batteries are preferably used as traction power sources for HEVs, PHEVs, or BEVs. Lithium-ion batteries may also be used as power sources for moving objects other than vehicles (for example, trains, ships, and aircraft), and as power sources for electrical products such as information processing devices.

The present disclosure is not limited to the above embodiment. The above embodiment is merely illustrative, and any structure having substantially the same configuration as, and having similar functions and effects to, the technical idea described in the claims of the present disclosure is included in the technical scope of the present disclosure.

### Example 1

### Preparation of Cathode Active Material

A cathode active material composed of primary particles having a composition of LiNi_{0.95}Mn_{0.05}O₂ was produced as described below.

### Preparation of Aqueous Raw Material Solution

NiSO₄ and MnSO₄ were prepared as raw materials, and these materials were dissolved in deionized water to prepare an aqueous raw material solution. The molar ratio of Ni and Mn in the aqueous raw material solution was adjusted to Ni:Mn=95:5. The concentration of the aqueous raw material solution (the proportion of all the raw materials in the aqueous raw material solution) was 20 mass %.

### Dehydration and Pre-Calcination

A certain amount of aqueous NH₃ solution was placed in a reaction vessel, and while stirring with a stirrer, the inside of the reaction vessel was purged with nitrogen. An aqueous NaOH solution was then added to the reaction vessel, and while maintaining the pH at an alkaline level (pH=12) and keeping the temperature constant, the aqueous raw material solution and the aqueous NH₃ solution were added dropwise into the reaction vessel to precipitate a transition metal hydroxide. After completion of the precipitation reaction, the precipitate was subjected to dehydration and pre-calcination under the following temperature and pressure conditions.
Temperature: 120° C.
Time: four hours
Pressure: 0.2 MPa

### Recovery of Precursor

After the pre-calcination, the precipitate was washed with water. The washed precipitate was filtered to recover the transition metal hydroxide. The recovered transition metal hydroxide was then dried at 110° C. for 12 hours to evaporate moisture (to obtain a dried material). A precursor was thus prepared.

### Mixing of Li Raw Material

The obtained precursor (transition metal hydroxide) and LiOH were mixed in a mortar such that the molar ratio of Li to the total amount of transition metal species (Me) contained in the transition metal hydroxide was 1.0 (Li/Me=1.0). The mixture was then further mixed with LiOH as a molten salt at a ratio of Li/Me=0.4. That is, the precursor was mixed with LiOH in an amount such that Li/Me=1.4.

### Calcination

The mixture was calcined at 500° C. for three hours in a muffle furnace. The calcined mixture was placed in a sagger with an alumina weight placed on it, and in this state, was further calcined at 780° C. for 12 hours.

### Water Washing

The calcined product was pulverized in an agate mortar to a particle size of 0.2 mm or less, and washed with pure water to remove LiOH. The obtained cake was then vacuum dried at 90° C.

### Re-Calcination

The dried product was re-calcined at 500° C. for three hours in an oxygen stream. After the calcination, the product was disaggregated to a predetermined particle size using a hammer mill. A cathode active material composed of primary particles having a composition represented by LiNi_{0.95}Mn_{0.05}O₂ was thus obtained.

### Fabrication of Battery

A slurry for forming a cathode active material layer, namely a slurry containing the above cathode active material and N-methyl-2-pyrrolidone (NMP) serving as a solvent, was applied onto a metal foil serving as a cathode current collector using a film applicator with a thickness adjustment function (manufactured by Allgood Co., Ltd.). After coating, the coated metal foil was dried on a hot plate at 80° C. for five minutes to evaporate the NMP solvent, thereby forming a cathode active material layer on the cathode current collector. A cathode including the cathode current collector and the cathode active material layer was thus obtained.

An anode composite paste containing natural graphite as an anode active material was applied onto the surface of a metal foil serving as an anode current collector using a film applicator with a thickness adjustment function (manufactured by Allgood Co., Ltd.). The coated metal foil was then dried at 80° C. for five minutes in a dryer. An anode having an anode active material layer on the anode current collector was thus prepared. A 1 M LiPF₆ solution containing LiPF₆ as an electrolyte and ethylene carbonate (EC), dimethyl carbonate (DMC), and ethyl methyl carbonate (EMC) as solvents in a volume ratio of EC/DMC/EMC=3/4/3 vol % was prepared as an electrolyte solution. The cathode, a separator, and the anode were stacked, the separator was impregnated with the electrolyte solution, and a small laminate cell was fabricated in which the power-generating element was housed in an Al laminate film pouch.

### Example 2

In preparing the aqueous raw material solution, NiSO₄, CoSO₄, and MnSO₄ were used as raw materials. The molar ratio of Ni, Co, and Mn in the aqueous raw material solution was adjusted to Ni:Co:Mn=90:5:5.

In the mixing of the Li raw materials, the precursor and LiOH were mixed in a mortar at a ratio of Li/Me=1.0. The mixture was then further mixed with LiOH as a molten salt at a ratio of Li/Me=0.6. That is, the precursor was mixed with LiOH in an amount such that Li/Me=1.6.

In the calcination, the mixture was calcined at 500° C. for three hours, and then, without placing a weight, was continuously calcined at 780° C. for 12 hours.

Except for these differences, a cathode active material composed of primary particles having a composition represented by LiNi_{0.90}Co_{0.05}Mn_{0.05}O₂ was prepared and a cell (small laminate cell) was fabricated in the same manner as in Example 1.

### Comparative Example 1

In the mixing of the Li raw materials, the precursor and LiOH were mixed in a mortar at a ratio of Li/Me=1.0. The mixture was then further mixed with LiOH as a molten salt at a ratio of Li/Me=0.2. That is, the precursor was mixed with LiOH in an amount such that Li/Me=1.2.

Except for these differences, a cathode active material composed of primary particles having a composition represented by LiNi_{0.90}Co_{0.05}Mn_{0.05}O₂ was prepared and a cell was fabricated in the same manner as in Example 2.

### Comparative Example 2

In the mixing of the Li raw materials, the precursor and LiOH were mixed in a mortar at a ratio of Li/Me=1.0. The mixture was then further mixed with LiOH as a molten salt at a ratio of Li/Me=0.2. That is, the precursor was mixed with LiOH in an amount such that Li/Me=1.2.

In the calcination, the mixture was calcined at 500° C. for three hours, and then, without placing a weight, was continuously calcined at 780° C. for 12 hours. An agate mortar was used instead of the hammer mill in the disaggregation after the re-calcination.

Except for these differences, a cathode active material composed of primary particles having a composition of LiNi_{0.95}Mn_{0.05}O₂ was prepared and a cell was fabricated in the same manner as in Example 1.

### Evaluation

### XRD Measurement

The cathode active materials obtained in Examples 1 and 2 and Comparative Examples 1 and 2 were subjected to X-ray diffraction measurement (XRD measurement) using synchrotron X-rays (17 keV, monochromatic). The XRD measurement was performed at BL5S2 of the Aichi Synchrotron Radiation Center (radiation facility). The XRD measurement was performed by sealing a measurement sample (cathode active material) in a glass capillary tube (inner diameter: 0.05 mm) and setting the measurement time to 10 minutes.

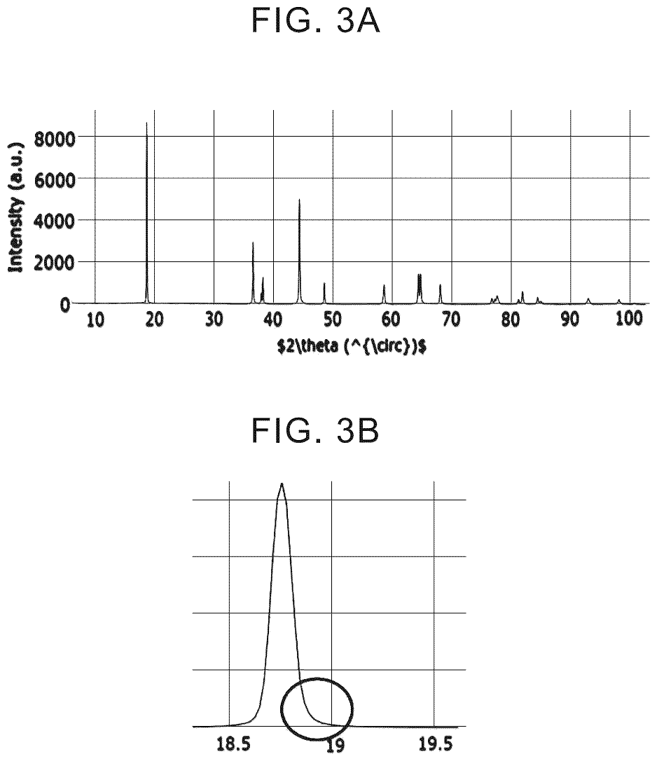

As a result, each of the cathode active materials obtained in Examples 1 and 2 and Comparative Examples 1 and 2 had, as the main phase, a layered rock-salt crystal phase belonging to the space group R-3m, and a peak derived from the (003) plane was observed at 2θ=18° to 19°. From the observed peak, dₚₑₐₖ, d_{low}, and d_{high} were calculated by the method described above, and the asymmetry degree ((dₚₑₐₖ−d_{high})/(d_{low}−dₚₑₐₖ)) was calculated. The results are shown in Table 1. As a representative result, an XRD pattern observed in Example 1 is shown in FIGS. 3A and 3B. FIG. 3A is a diagram showing the entire XRD pattern, and FIG. 3B is a diagram in which the peak portion derived from the (003) plane is extracted from FIG. 3A.

### Cycle Capacity Retention

Using the batteries obtained in Examples 1 and 2 and Comparative Examples 1 and 2, the cycle capacity retention was measured. First, the initial discharge capacity of the battery was determined. Specifically, the battery was charged to 4.25 V and discharged at 0.1 C to 2.5 V, and the initial discharge capacity was determined at 25° C. The initial discharge capacity was calculated as the capacity (mAh g⁻¹) per weight (g) of the cathode active material contained in the cathode.

Next, a cycle test was conducted under the following conditions.
Ambient temperature: 60° C.
Number of cycles: 100
Current rate: 0.3 C
Voltage range: 4.25 V to 2.5 V

After the cycle test, the discharge capacity (mAh g⁻¹) after 100 cycles was determined in the same manner as above. The discharge capacity after 100 cycles was divided by the initial discharge capacity to determine the cycle capacity retention (%). The results are shown in Table 1.

TABLE 1

| | | | Capacity |
|---|---|---|---|
| | Primary particle | Asymmetry | retention |
| | composition | degree | (%) |
| Example 1 | LiNi_{0.95}Mn_{0.05}O₂ | 1.19 | 98 |
| Example 2 | LiNi_{0.90}Co_{0.05}Mn_{0.05}O₂ | 1.15 | 98 |
| Comparative | LiNi_{0.90}Co_{0.05}Mn_{0.05}O₂ | 1.05 | 95 |
| Example 1 | | | |
| Comparative | LiNi_{0.95}Mn_{0.05}O₂ | 0.89 | 92 |
| Example 2 | | | |

As shown in FIGS. 3A and 3B, it was confirmed that the cathode active material of Example 1 had a peak derived from the (003) plane. As circled in FIG. 3B, it was confirmed that tailing was observed on the high-angle side of the (003) plane peak. As shown in Table 1, it was confirmed that good capacity retention was obtained when the asymmetry degree was 1.14 or more, particularly 1.15 or more.

What is claimed is:

1. A cathode active material for use in a lithium-ion battery, wherein:
the cathode active material is a single-crystal active material composed of crystalline primary particles;
the primary particles have a composition represented by LiₓNiₐCo_{b}Mn_{c}O_{y} (where 0.1≤x≤1.5, 0.5≤a≤1.0, 0≤b≤0.3, 0≤c≤0.3, a+b+c=1.0, and 1.5≤y≤2.1);
the primary particles have, as a main phase, a crystal structure belonging to space group R-3m; and
an asymmetry degree calculated from (dₚₑₐₖ−d_{high})/(d_{low}−dₚₑₐₖ) is 1.14 or more, where dₚₑₐₖ represents a plane spacing calculated from 2θ of a peak derived from reflection at a (003) plane and obtained by X-ray diffraction, d_{low} represents a plane spacing calculated from 2θ on a low-angle side corresponding to 5% of a peak intensity of the peak, and d_{high} represents a plane spacing calculated from 2θ on a high-angle side corresponding to 5% of the peak intensity of the peak.

2. The cathode active material according to claim 1, wherein the asymmetry degree is 1.20 or less.

3. The cathode active material according to claim 1, wherein the b is 0, and the c is more than 0.

4. The cathode active material according to claim 1, wherein a particle size of the primary particles is 0.5 μm or more.

5. A lithium-ion battery comprising: a cathode active material layer; an anode active material layer; and an electrolyte layer disposed between the cathode active material layer and the anode active material layer, wherein
the cathode active material layer contains the cathode active material according to claim 1.
